(19) United States
(12) Patent Application Publication
(10) Pub. No.: US 2024/0020712 A1
(43) Pub. Date: Jan. 18, 2024

(54) SYSTEM AND METHOD FOR DISTRIBUTED INDIVIDUAL EXPERIENCE COLLECTION, ANALYSIS, AND CONTINUAL SINGLE-PARTICIPANT EXPERIENCE TRIALS AND BURNOUT RISK DETECTION AND MITIGATION

(71) Applicant: Kelton Isaac Shockey, Longmont, CO (US)

(72) Inventor: Kelton Isaac Shockey, Longmont, CO (US)

(21) Appl. No.: 17/867,535

(22) Filed: Jul. 18, 2022

(51) Int. Cl. G06Q 30/02

(52) U.S. Cl. CPC G06Q 30/0201

(57) ABSTRACT

A system and method for monitoring and tracking the ongoing experience of an individual or groups of individuals using a distributed sensor array capable of modifying data collection methodologies at a single sensor level based on single participant inputs and system-wide intelligence. The monitoring system includes a subsystem configured to process, analyze, and report the ongoing status of each individual system participant dynamically as conditions change and inputs are adjusted. The system and method for continuous monitoring can provide individual level motivation and risk profiles in addition to system level insight into the environment and factors affecting groups of individuals within such environment in unique ways.

### RELATED APPLICATIONS

This application claims priority to U.S. Provisional Application Ser. No. 63/223,027 (hereinafter “'027 provisional”), filed 18 Jul. 2021 which is incorporated herein by reference in its entirety.

### BACKGROUND

The field of the disclosure relates to real-time and interval data collection using distributed individual multi-functional end user sensors within grouped sensor networks for analysis and sensor system optimization for, in one implementation, improving employee satisfaction in workplace environments.

Individual level experience collection and reporting is limited by data collection using point-in-time survey techniques typically designed to assess group sentiment holistically. A lack of individualization to data collection and reporting over time using standardized questions and delivery timeframes constrains the data output's value for dynamic and continuous applications over time.

### SUMMARY OF THE INVENTION

The invention comprises a system for individual experience and reaction data collection using a distributed, secure, individual sensors connected a cloud-based processing, analysis, and intelligence platform. These sensors are configured to report measurements into the central processing platform where the experience measurements can be processed, analyzed, and monitored over time. The invention discloses a system configured to ingest, process, and analyze each sensor input individually to determine the experience of the individual sensor user at any given time and predict what experience events (e.g., long hours, unproductive meetings, poor social engagement, malfunctioning equipment, etc.) are most correlated with positive or negative trends. The invention furthermore comprises a method for determining the real-time and predicted experience of an individual based on historic individual sensor readings.

### BRIEF DESCRIPTION OF THE INVENTION

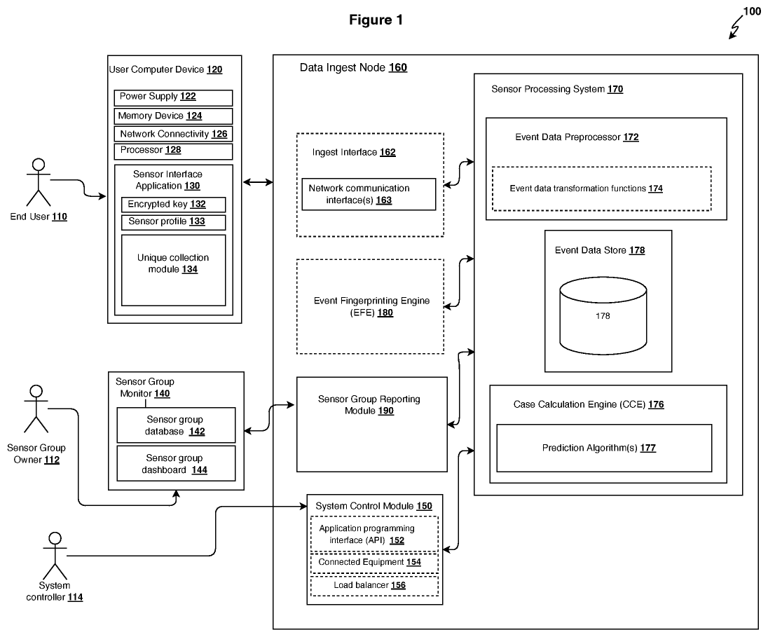

FIG. 1 shows one exemplary schematic system for a distributed individual experience data collection, analysis, and continual single-participant experience trial application.

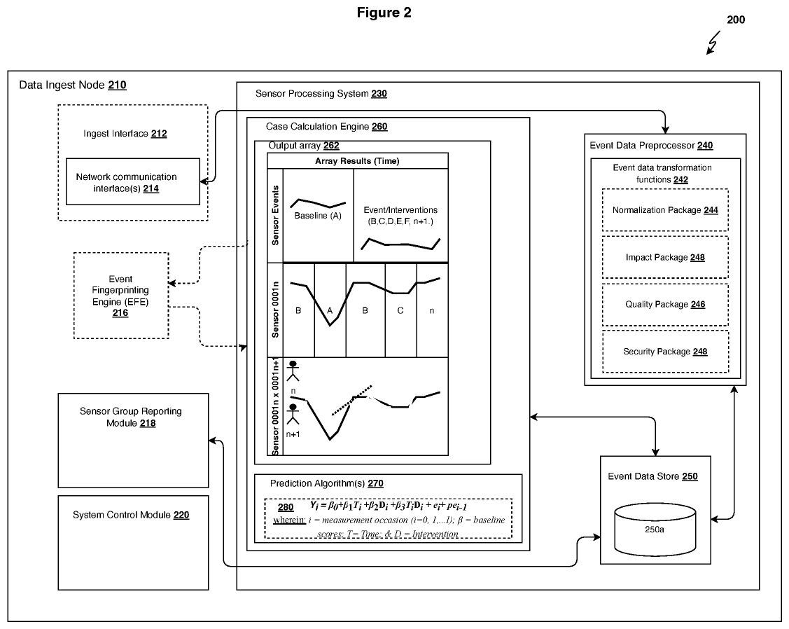

FIG. 2 schematically illustrates an exemplary Data Ingest Node with data processing, analysis, and reporting functions associated with continuous single-participant sensor data ingestion.

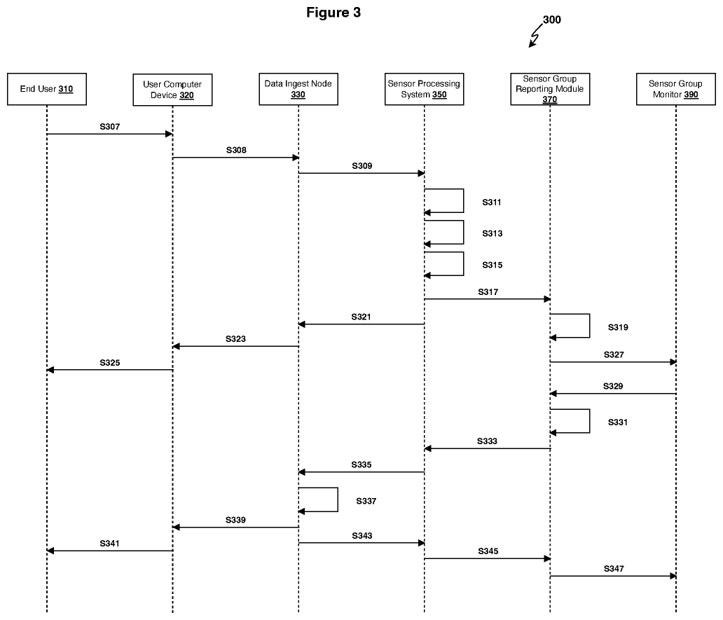

FIG. 3 is a sequence diagram for an exemplary sensor data ingestion, processing, analysis, and reporting, according to an embodiment.

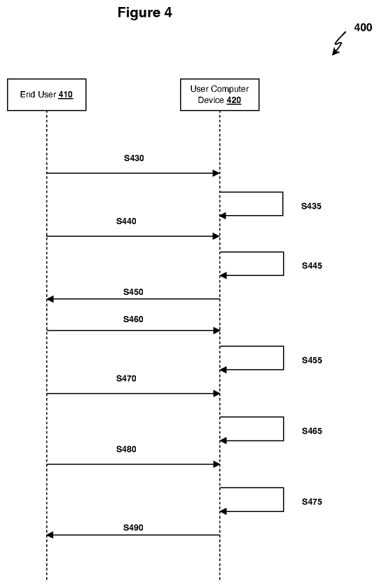

FIG. 4 is a sequence diagram for an exemplary end user interaction with the Sensor Interface Application residing on the User Computer Device, according to an embodiment.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION OF THE FIGURES

In the following specification and the claims, reference will be made to specific terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” is not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory.

Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the times of occurrence of the associated events, the time of measurement and collection of predetermined data, the time for a computing device (e.g., a processor) to process the data, and the time of a system response to the events and the environment. In the embodiments described herein, these activities and events occur substantially instantaneously.

Furthermore, as used herein, the term “individual” refers to, in one embodiment, an individual human being. However, in other embodiments of the invention, and individual may include additional intelligent systems capable of positive or negative response reporting, such as an artificial intelligence system, a machine learning system, a complex sensor system operating under intelligence or dynamic decision parameters, etc. In the invention herein, individuals provide experience data to the interface, which may include emotional states, health, wellness metrics, location metrics, etc. at any given time. Taken together, these data collected at the individual level are herein discussed as sensor data collected from a single individual, and including, but not limited to the data discussed above. For example, in one embodiment, the individual end user will engage with the individual sensor and provide their emotional reaction to events taking place around them or to them via tiered surveys, questionnaires, tests, and other inputs (e.g., voice, text).

The present system and methods herein advantageously utilize single participant research methodologies to conduct continuous individualized experience logging to determine positive and negative experience profiles for unique individuals and groups of individuals within varying environments and contexts (e.g., at work, in school, etc.). In such environments, the present system can be deployed to make data driven management and improvement decisions on the basis of individual motivation and demotivation or burnout risk profiles. The present embodiments may be implemented to augment or, in some circumstances, replace conventional experience assessment surveys that rely on static, non-individualized questionnaires to log responses and assess individual experience. A person of ordinary skill in the art though, upon reading and comprehending the present description and associated illustrations, will understand that other examples of continuous individual reporting technologies may be implemented according to the novel and advantageous principles herein.

The present solutions are thus advantageous either implemented as standalone systems to assess and execute management decisions in complex environments with a plurality of individual sentient actors, each continuously making unique decisions that can affect and modify the entire system, or as a complementary system to existing engagement, wellness, or health monitoring systems used in such environments today. The present embodiments are of particular value in the application to complex environments characterized by numerous independent actors operating under unique motivation models in high-risk scenarios where individual decisions can lead to changes in the system that affect all components, such as in healthcare, law enforcement, or military settings, in one embodiment.

FIG. 1 is a schematic illustration of a monitoring system 100 configured to collect experience inputs from the end users 110 and ingest, process, analyze, and deliver insight on end users 110 to the sensor group owner 112. System 100 is illustrated as an exemplary architecture to implement the monitoring system of the present disclosure. Other architectures are contemplated by the present inventors, which do not depart from the scope of the embodiments. Furthermore, for ease of explanation, redundant components that may be implemented within the system 100 are not illustrated, nor are other components, objects, and sequences that may be conventionally utilized in an experience monitoring system.

In an exemplary embodiment of system 100, experience events are communicated via end user computer devices 120 into the data ingest node 160 which is configured to process, analyze, and report on inputs collected across a plurality of computer devices 120 simultaneously while retaining unique processing models within the case calculation engine 176 for each end user 110 and associated group of end user 110 participants in the sensor group managed by the sensor group owner 112. In the exemplary embodiment illustrated in FIG. 1, processes or steps taken by the system 100 are described relative to how the respective to how the system 100 will ingest and process individual sensor interface 130 data and return insight to the sensor group owner 140 or other party (not shown). Individual process steps that may also be performed by system 100 parties (e.g., 110, 112, or 114), or other persons and/or devices associated therewith are not shown.

In the exemplary embodiment of system 100 shown in FIG. 1, one further exemplary system 100 application is in a healthcare system, where the healthcare professionals (e.g., Registered Nurses, Doctors, Administrations, Support Staff, etc.) are the end users 110 and the hospital system they work at is the sensor group owner 112. In this exemplary application, an individual nurse 110 would connect to the sensor interface application 130 via a computer device 120 and would log individual reactions to their workday utilizing the interface 130. The system 100 would supply that nurse's device with a unique collection module 134 based on the hospital's unique requirements and the intelligence developed for that individual via ongoing engagement with the data ingest node 160 serving that hospital 112. In this exemplary scenario the nurse may log negative or positive interactions and emotions throughout the day based on the unique collection module's 134 current response options. Those reactions are then transferred to the data ingest node 160 in real-time (in this example via an electronic communications network) where it is processed by the sensor processing system 170. The processing that the node is configured to accomplish is shown, in one exemplary embodiment, in FIG. 2. The inventors herein anticipate the system 100 to have wide applicability and novel utility in many related fields, including but not limited to, law enforcement, business, service industries, and military fields.

In the exemplary embodiment of system 100 shown in FIG. 1, the end user 110 supplies continuous experience inputs through the user computer device 120 configured to accept such data inputs via the sensor interface application 130. The sensor interface application 130 is configured to securely transmit the data collected from 110 to the data ingest node 160 where it is processed. The data ingest node 160 is optionally configured with an ingest interface 162 such that 110 or other system users (e.g., 112 and/or 114) can interact and directly with 160 and add, remove, or modify the data processing configurations. In the exemplary embodiment of system 100, the data ingest node 160 is one of a plurality of data ingest nodes located with a secure server environment and accessible via a network communication interface(s) 163. In other embodiments, the data ingest node may be located in a secure local environment without or with limited network access, such as may be advantageous in applications with highly confidential or secure data inputs. In the embodiment shown in FIG. 1, the data collected from 110 via 130 is ingested by the data ingest node 160 using a sensor processing system 170 to process, store, and analyze input data. The sensor processing system 170 is configured to utilize an event data processor 172, and event data store 178, and a case calculation engine 176, to deliver reports to a sensor group reporting module 190. Module 190 is configured to sort specific data requests from a sensor group monitor 140 that can be accessed by the sensor group owner(s) 112.

In some embodiments of system 100, some or all of parties 110, 112, and/or 114 are in direct or indirect operable communication with an electronic communications network (e.g., Internet, LAN, WAN, etc.). The system controller 114 can be the same as or unique from 112 and 110. In some embodiments, a single participant will hold all roles, such as in individualized health and wellness monitoring performed by an individual. In other embodiments, such as shown in FIG. 1, these actors are unique entities with one or more individual participants interacting with the system 100 in distinct capacities with different capabilities and controls.

In the exemplary embodiment shown in FIG. 1, the system controller can access and configure the entire node 160 via a system control module 150 which may, in some embodiments, include an application programming interface 152, connected equipment 154, and or a load balancer 156 configured to balance system 100 loads on the processing capabilities of 160 nodes within the system 100. As described above, in other embodiments, the system controller role 114 can be included in either/or the 112 or 110 roles. For example, in a highly classified or secure embodiment of the system 100, the sensor group owner 112 may require all system privileges associated with 114 to ensure compliance with security, safety, or data confidentiality requirements.

In the exemplary embodiment shown in FIG. 1, the end user's 110 experience reaction data collected at the device 120 are processed by an event data preprocessor 172. The event data preprocessor 172 applies a series of optional event transformation functions (shown in detail in FIG. 2 and FIG. 3), including but not limited to, a normalization function package 242 configured to normalize and standardize input data, an impact calculation package 248 configured to calculate and score the ingested data on impact metrics, a quality function package 246, configured to calculate and score ingested data on data quality metrics, and a security package 248, configured to apply system 100 security rules and apply required data security gates as required by the specific implementation of the invention. Once ingested data is preprocessed 170, shown in S311, it is transferred to the storage container located in an event data store 178 (shown in S313). In this exemplary implementation this order of processes is utilized for clarity, however, the data ingest node 160 may be configured to complete all processes contained within in any order required. The case calculation engine 176 then applies a series of prediction algorithms 177 (S315) configured to produce individual motivation and demotivation insights and profiles which are stored within the data store 178 and remain associate with the end user 110. In FIG. 3, these prediction algorithm 177 results are delivered to the sensor group owner 112 (in S317 to the sensor group reporting module 190, 370 and then in S327 to the sensor group monitor 112, 390).

In an optional configuration of the exemplary embodiment of system 100 shown in FIG. 1, an event fingerprinting engine 180, (also shown in FIG. 2 216) is configured to ingest incoming sensor data from the end users 110 and create unique profiles for each user to determine an ongoing likelihood calculation of relatedness between individual events logged. The fingerprinting engine 180 utilizes dynamic machine learning algorithms to learn to associate common events across user engagements and establish a statistical probability of relatedness between single user events and multiple user events. In the latter implementation, the fingerprinting engine, in one exemplary embodiment utilizes additional data elements collected at the interface 130 to augment predicative capability. For example, in this exemplary embodiment, the interface 130 is configured to collect location-based data from the device 120 (e.g., GPS) and/or relational location between users 110 (e.g., using Bluetooth signal strength between devices 120). In such exemplary embodiment, the fingerprinting engine 180 is configured to apply these additional data augmentations to ingested data to improve the predictive fingerprinting algorithm and return additional predictions and associations between users 110.

In the exemplary embodiment shown in FIG. 1, once the individual end user 110 experiences an event and chooses to utilize the system 100, they log their emotional reaction within the sensor interface application 130 which creates a sensor event reaction data package, shown in FIG. 3 S307 and FIG. 4 S440 (representing the same data transaction and herein used interchangeably). The sensor event reaction package S440 is transferred from the device 110 (also shown in FIG. 3 S310 and FIG. S4 410) to the sensor processing system 170, 230, 350 via the data ingest node 160, 210, 330. Once processing within 170 is completed, the results are transferred to the reporting module 190, 218, 370, where they are configured for delivery to the sensor group monitor 140, 390 where they are displayed graphically as the total system group results or individual components and insights determined by the case calculation engine 176, 260 are displayed as actionable intelligence for the group owner 112. These insights are displayed within the group monitor 140, 390 configured to display a sensor group database 142 and dynamic sensor group dashboard 144.

The exemplary embodiment of system 100 is additionally shown in further detail in system 200 shown in FIG. 2. In FIG. 2 the same exemplary embodiment shown in FIG. 1 is provided in additional detail, including the optional functions that are applied by the event data processor 240, 172, and an exemplary output array 262 and prediction algorithm 270. In this exemplary implementation, the case calculation engine 260, 176 applies a plurality of predictive algorithms 270 to data located in the event data store 250, 178, including for example, but not limited to, the exemplary algorithm 280. In this example, the case calculation engine 260 is configured to apply the predictive algorithm 280 to end user 110 reaction data continuously. The example algorithm 280 compares interventions (variable D) over time series reactions from end user 110 with observed and predicted values. As the end user 110 engages with the system 100, 200, over time and logs reactions that the case calculation engine classifies as like-type (e.g., D), the predictive algorithm is executed to continuously search for statistically significant relationships between the end user 110 experience state (as captured by all reactions) and specific events captured and classified, such as D. The system 200 can be configured to determine like events independently within the case calculation engine 260, or optionally, utilize the event fingerprinting engine 216 to do this independently and develop improved machine learning models for each end user 110. The prediction algorithm represents just one optional example of the predictive algorithms 280 that the case calculation engine can be configured to apply to event data store 250 data collected from end users 110.

In this exemplary embodiment shown in FIG. 2 and described above, the output array 262 shows an example result for an individual sensor over time where the calculation engine 260 has determined a baseline (A) for that sensor and found additional reactions to categorize as B, C, D, etc. The calculation engine 262 is configured to organize these reaction events into single sensor instances (e.g., how does an individual react differently over time to the same event type) or make comparisons across related sensors within a sensor group (e.g., does sensor 0001n interacting with sensor 0001n+1 result in a significant effect on either single sensor). These relational comparisons can be optionally based on sensor group hierarchy models that are predetermined by the sensor group owner 112, or by additional metrics attached to sensor data from the device 120, such as location or proximity (e.g., utilizing radio-frequency signal strength, such as Bluetooth signals between devices 120).

The exemplary embodiment shown in system 100 and 200 is shown in sequence diagrams FIG. 3 and FIG. 4. In FIG. 4 the end user 410 (also 310 and 110) initiates the onboarding event in S430 by proving account creation details to the sensor interface application 130 located on the user computer device 420 (also 320 and 120). The user computer device 420 is configured with a power supply (e.g., battery, solar panel, or cable) 122, a memory device 124, a network connection 126, and a processor 128, which together can execute the sensor interface application 130. The sensor interface application 130 is configured with a secure encrypted key 132 which encrypts data traffic between the application 130 and the ingest node 160. Additionally, the application 130 includes a sensor profile 133 where details on the individual end user 410 are collected and stored locally to ensure system functionality and security even without a persistent or secure connection (e.g., via electronic communications network) to the data ingest node 160. As the end user 410 interacts with the device 420 by logging reactions, such as in S440, S460, S470, or S480, the application 130 is configured to utilize a unique collection module 134 to deliver the appropriate sensor input options to the end user. For example, in one embodiment in the healthcare setting, the end user 410 is a health care professional and they initiate an account with sequence S430 on their computer device 420 (e.g., a cellphone, tablet, computer, wearable device, etc.). The device 420 validates the user's credentials with the node 160 in sequence S435. The healthcare professional then can engage with the device 420 at will to log reactions to their workday (e.g., a frustrating event with a patient due to missing information) in a continuous series of event reactions shown in S440, S460, S470 and S480. While several reaction events are shown in FIG. 4, the embodiment anticipates continuous engagement leading to hundreds and thousands of event reactions over time per device 420. In this example, the healthcare professional logs their reaction S440 and the device 420 securely transfers that data along with additional profile data to the node 160. Once processing, as described above, is completed within the node 160, the system may optionally return an update or report to the end user 410 via sequence S450 (e.g., a summary, results, analysis, or updates to the unique collection module). This series of sequences continues indefinitely as the end user 410 engages with the system in this embodiment. In some embodiments, the end user 410 will log additional data elements beyond those required by the unique collection module 134 (e.g., time, date, location, emotion, reason, experience etc.) which may optionally include data transformation sequences within the device 420 or within the node 160. Such sequences are shown in S455, S465, and S475 and can represent functions such as speech to text algorithms, natural language processing algorithms, and/or language translation algorithms. For example, if the healthcare professional 410 logs a reaction and includes an optional text note explaining further the reaction, the sequence S455 could be used to process that text for keywords and sentiment elements.

The exemplary embodiment of system 100 discussed above, is further shown in the sequence diagram FIG. 3 where the end user 310 (also 410 and 110) engages with the computer device 320 (also 420 and 120) logging event reactions over time and that data is packaged and passes through a series of sequences at the data ingest node 330 (also 210 and 160) and processed by the sensor processing system 370 (also 170 and 230) before results are delivered to the sensor group module 370 (also 140 and 218) and displayed in the sensor group monitor 390 (also 140) for interaction with the sensor group owner 112. In FIG. 3, the end user 310 logs a reaction shown by S307 on their device 320, which is packaged with additional data contained in the sensor profile 134 and forwarded to the data ingest note 330 in S308. The data ingest node 330 initiates S309 and a series of data processing functions are executed, including, for example S311 transformation, S313 storage, S315 case calculation and predictive algorithm analysis. Analysis results are returned via S317 to the sensor group reporting module 370 where they are optionally compared and correlated with similar sensors within the group in S319 and reported to the sensor group monitor in S327 for display and interaction by 112. In S321 an exemplary return report is sent back through the node 330 to the device 320 via S323 and delivered to the end user 310 in S325. An example return report may include summary processing results or additional configuration options for the device 320 based on machine learning models executed within the sensor processing system 350. Such additional configurations, in one embodiment, may include adjustments to the data collection interface (e.g., additional questions or survey options). The sensor group monitor 390 can optionally, submit specific change requests or data analysis queries, shown in S329 to the sensor group reporting module 370. These requests are validated in S331 (e.g., ensuring credentials, permissions, and privacy and security rules are followed) and if allowed in S331, returned to the processing system 350 via S333 and to the ingest node 330 via S335 for logging and fulfilment in S337. Once completed, the request is optionally delivered to the end user 310 via S339 and S341. When results are available, the report based on the query is returned via S343, S345, and S347 to the sensor group monitor 390.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A system for individual experience and reaction data collection using a distributed sensor array, comprising:
a collection sensor subsystem configured to collect direct experience data from sensors associated with an individual; and
a processing subsystem communicatively coupled to the collection sensor subsystem and configured to ingest, transform, store, and analyze the individual sensor data to sense the individual's physical and emotional status.

2. The distributed data collection sensor subsystem of claim 1, wherein the collection sensor subsystem comprises an end user computer device configured to securely collect, store, transmit, and report individual experience data to the processing subsystem.

3. The system of claim 2, wherein the data collection sensor subsystem is configured to send individual sensor readings to a cloud-based processing application when requested.

4. The system of claim 2, wherein the data collection sensor subsystem is configured to send individual sensor readings to a cloud-based processing application continuously in real-time as readings are collected by the data collection sensor subsystem.

5. The distributed processing subsystem of claim 1, wherein the processing subsystem comprises a data preprocessor, a data storage device, and a data analysis calculation engine.

6. The system of claim 5, wherein the storage subsystem comprises a plurality of separate storage units.

7. The system of claim 5, wherein the processing subsystem is further configured to apply one or more event data preprocessing functions, comprising normalization, impact and quality scoring, and translation packages.

8. The system of claim 5, wherein, the data analysis calculation engine is configured to apply a plurality of predictive algorithms to the data collection sensor subsystem data.

9. The system of claim 5, wherein the processing subsystem further comprises an event fingerprinting engine configured to assign a likeness score and probability score between individual sensor reading types.

10. A system for collecting and analyzing inputs from individual sensors in a distributed sensor array configured to collect input and improve sensor queries to optimize predictive value, and request modified data packages from individual sensors, comprising:
a distributed sensor network subsystem configured to collect direct input from individual sensor users; and
a sensor network processing subsystem communicatively coupled to the distributed sensor network and configured to apply a plurality of predictive algorithms to individual sensor inputs to calculate sensor query updates to optimize specific relationships between sensor data.

11. The system of claim 10, further comprising an event fingerprinting engine configured to assign a likeness score and probability score between individual sensor reading types.

12. The system of claim 11, further comprising a calculation engine configured to predict and validate relationships between unique individual sensor reading types.

13. The system of claim 11, further comprising a plurality of predictive algorithms configured to assess statistical significance between individual sensor reading types utilizing continuous multivariate linear regression analysis.

14. A method for individual experience and reaction data collection using a distributed sensor array, the method comprising the steps of:
generating a secure connection between a plurality of individual collection sensors and a sensor processing network;
collecting real-time individual sensor input data describing the experience of an individual sensor user;
delivering, after sensor verification, the individual sensor data package to the sensor processing network;
analyzing individual sensor data packages in the sensor processing network to determine interdependence of unique sensor readings and associated individual sensor event types.

15. The method of claim 14, wherein the interdependence of unique sensor readings is further analyzed by an event fingerprinting engine to determine likeness, correlation, and probabilities of individual sensor readings.

16. The method of claim 15, further comprising the step of delivering complete analysis reports for each sensor to a sensor group for data display and intelligence gathering.

17. The method of claim 15, further comprising, after individual sensor analysis, of analyzing a plurality of individual sensor readings in combination to determine sensor group insights and commonalities between individual sensors.

18. The method of claim 14, wherein the step of collecting real-time individual sensor input data comprises a sub step of associating each input with a specific sensor group and storage location.

19. The method of claim 14, wherein said individual sensor event types are determined by applying a pre-defined discretization to sensor readings.

20. The method of claim 14, wherein said individual sensor event types are determined by multivariate regression analysis predictions derived from historical individual sensor data.
